(19) United States
(12) Patent Application Publication
(10) Pub. No.: US 2002/0100034 A1
(43) Pub. Date: Jul. 25, 2002

(54) Application personality

(76) Inventor: John F. Croix, Austin, TX (US)

Correspondence Address: John J. Bruckner, FULBRIGHT & JAWORSKI, LLP, Suite 2400, 600 Congress Avenue, Austin, TX, 78701, US

(21) Appl. No.: 09/768,037

(22) Filed: Jan. 22, 2001

(51) Int. Cl. G06F 9/44

(52) U.S. Cl. 717/163

(57) ABSTRACT

Systems and methods are described for using a library with a plurality of application programs. In particular, the systems and methods enable the tuning of the response of a library with application program specific macros. A method includes: providing an interface for communication between a set of first programs and a second program; and providing to the second program at least one of a set of third programs associated with at least one of the set of first programs, in response to a dataset associated with the at least one of the set of first programs. The at least one of the set of third programs may selectively modifies the interface for communication between the second program and the at least one of the set of first programs. The set of first programs can be the application programs employed in a design flow of a circuit, the second program can be an active library for providing a macro facility to the application programs, and the set of third programs can be plug-ins such as a set of shared object libraries or dynamic link libraries. The systems and methods provide advantages in that the active library being a shared object or a dynamic link library can be readily extended through the use of plug-ins for dynamic integrated circuit calculation and modeling, and for rapidly achieving design convergence within a design flow.

### BACKGROUND OF THE INVENTION

1. Field of the Invention

The invention relates generally to the field of computer science. More particularly, the invention relates to software. Specifically, a preferred implementation of the invention relates to use of a single shared entity such as a library with multiple application programs.

2. Discussion of the Related Art

Support and usage of a single shared entity across multiple applications and vendors can be a daunting task. In particular, it can be difficult to provide a communication interface between such a single shared entity and multiple application programs for a variety of environments, including databases and libraries. For example, within such an environment having disparate applications, while using a known Application Procedural Interface (API) with a set of predefined callbacks or calling routines, absent a protocol specification, it could be even more difficult to provide an efficient interaction between an application and a shared library entity.

In the semiconductor industry, multiple installed application programs such as software products for electronic design automation may interface with a design library having design and/or device characterization information. More specifically, for integrated circuits (ICs) using deep submicron process has led to the development of an open architecture named Open Library API (OLA). Although OLA provides a comprehensive Application Procedural Interface (API) that can be used by Electronic Design Automation (EDA) tools for the determination of cell and interconnect timing and power characteristics of ICs, performing unnecessary procedures could cause significant degradation of system performance. Moreover, a variation of results from similar computations performed under different set of conditions could make it even more difficult to cater to ever-increasing demand for performance and consistency across design flows. Heretofore, in design flows incorporating design tools from multiple EDA vendors, performance and consistency in calculation, modeling and efficient design convergence not been fully met.

What is needed is a solution that permits the use of a library with multiple applications. More particularly, in order to provide design convergence, in an efficient manner, calculation and modeling of delay, power, and other silicon device characteristics should be rapid and consistent across multi-vendor EDA tools used in a design flow.

### SUMMARY OF THE INVENTION

A goal of the invention is to provide a technique geared towards optimization of procedural interaction (e.g. one or more calls and/or callbacks) as well as making such interaction work with applications that may not adhere (strictly) to the calling conventions and/or protocol defined by that interaction. Another goal of the invention is to satisfy the above-discussed requirement for efficient usage of a design library with a set of design tools in a design flow in order to provide a rapid design convergence. A yet another goal is to satisfy the above-discussed requirement of increased performance and consistency.

One embodiment of the invention is based on a method, comprising: providing an interface for communication between a set of first programs and a second program; and providing to the second program at least one of a set of third programs associated with at least one of the set of first programs. In response to a dataset associated with the at least one of the set of first programs, the at least one of the set of third programs selectively modifies the interface for communication between the second program and the at least one of the set of first programs. Another embodiment of the invention is based on an electronic media, comprising a program for performing this method. Another embodiment of the invention is based on a computer program, comprising computer or machine readable program elements translatable for implementing this method. Another embodiment of the invention is based on an integrated circuit designed in accordance with this method.

Another embodiment of the invention is based on a method, comprising: providing an application procedural interface for communication between the set of first programs and the second program; and providing, through the use of the application procedural interface, to the second program at least one of a set of plug-ins from a database responsive to a dataset identified to be associated with the at least one of the set of first programs. Another embodiment of the invention is based on an electronic media, comprising a program for performing this method. Another embodiment of the invention is based on a computer program, comprising computer or machine readable program elements translatable for implementing this method. Another embodiment of the invention is based on an integrated circuit designed in accordance with this method.

Another embodiment of the invention is based on a method, comprising: communicating an indication form the first program to the second program; analyzing the indication to determine an interaction between the first and second program; and utilizing a third program to tune the interaction between the first program and the second program.

Another embodiment of the invention, a system, comprising: an interface to communicate between a set of first programs and a second program; and a set of third programs, wherein one of the set of first programs loading in the second program and the second program responsive to a dataset from one of the set of first programs loading in at least one of the set of third programs.

Another embodiment of the invention, a system, comprising: an application procedural interface for communication between the set of first programs and the second program; and a database including a set of plug-ins, wherein one of the set of first programs loading in the second program and the second program responsive to a dataset from one of the set of first programs loading in at least one of the set of plug-ins.

Another embodiment of the invention, a system, comprising: an application procedural interface for extending a dynamic library for use with a first application program and a second application program; a first plug-in, wherein the dynamic library loads the first plug-in to the first application program responsive to a first data; and a second plug-in, wherein the dynamic library loads the second plug-in to the second application program responsive to the second data.

These, and other, aspects of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the invention without departing from the spirit thereof, and the invention includes all such modifications.

### BRIEF DESCRIPTION OF THE DRAWINGS

A clear conception of the advantages and features constituting the invention, and of the components and operation of model systems provided with the invention, will become more readily apparent by referring to the exemplary, and therefore nonlimiting, embodiments illustrated in the drawings accompanying and forming a part of this specification, wherein like reference numerals (if they occur in more than one view) designate the same elements. It should be noted that the features illustrated in the drawings are not necessarily drawn to scale.

FIG. 1 illustrates a high-level block schematic view of a system, representing an embodiment of the invention.

FIG. 2A illustrates a block schematic view consistent with the system depicted in FIG. 1 with exemplary runtime details.

FIG. 2B illustrates a block schematic view consistent with the system depicted in FIG. 1 with exemplary runtime details.

FIG. 2C illustrates a block schematic view consistent with the system depicted in FIG. 1 with exemplary runtime details.

FIG. 3 illustrates an exemplary plug-in architecture consistent with the present invention.

FIG. 4 illustrates another exemplary plug-in architecture consistent with the present invention.

FIG. 5 illustrates a flow diagram of a process that can be implemented by a computer program, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail.

The context of the invention can include semiconductor design synthesis tools. The context of the invention can also include the support and operation of a timing analyzer. Using Application Procedural Interface (API), large, reusable design libraries can be developed to serve a variety of software products deployed for electronic design automation.

A set of first programs may be a set of application programs for electronic design automation. A second program may be a shared object library having a generic code for use with the set of first programs. Alternatively, the second program could be a dynamic link library having a plurality of generic macros for use with the set of first programs. A set of third programs may be a plurality of application specific shared objects, each application specific shared object having one or more application specific macros associated with the at least one of set of first programs. Alternatively, the set of third programs could be a plurality of application specific dynamic link libraries, each application specific dynamic link library having one or more application specific macros associated with one or more of set of first programs. A fourth program may be one or more active models, each active model having a dataset and an algorithmic content, the forth program being shared by the set of first programs. The systems and methods provide advantages in that a dynamic library can be readily extended through the use of the set of third programs such as plug-ins.

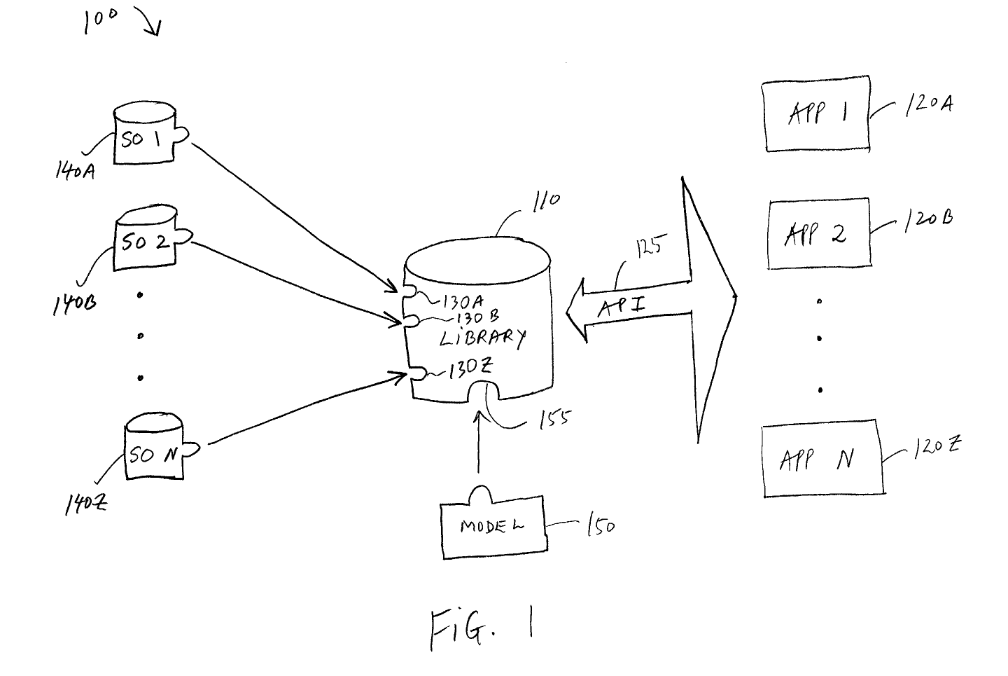

An overview of a system 100 that includes an embodiment of the invention will now be described. Referring to FIG. 1, a library 110 can be coupled to a plurality of application programs 120A through 120Z via an application procedural interface (API) 125. The library 110 can contain information on the electrical properties of some/many/all of the cells and/or interconnects in a design of interest.

Application procedural interface (API) 125 provides an interface for communication between the plurality of application programs 120A through 120Z and library 110. For example, a shared object (.so) or a dynamic link library (.dll) could be utilized as a software module, which may be invoked and subsequently executed at runtime by an application program. The invention includes the application procedural interface (API) 125. The API 125 comprises functions (not shown) such as calls and/or callbacks, which can be utilized for passing parameters including industry standard and proprietary parameters.

The library 110 can use a plurality of application personality sockets 130A through 130Z to load in a plurality of shared objects 140A through 140Z. The application personality sockets 130A through 130Z are adapted to receive/support respective shared objects 140A through 140Z. For example, shared objects 140A through 140Z could be plug-in(s) in different formats such as shared object libraries (.so) in UNIX platform or dynamic link libraries (.dll) in WINDOWS platform).

The application personality sockets 130A through 130Z will now be discussed in more detail. The code that loads a plug-in is called a socket. Accordingly, these application personality plug-ins are loaded into library 110 at loading points called “sockets.” A socket can be licensed to determine whether or not a plug-in is allowed to load. The application personality plug-ins could be licensable entities which may require their own license tokens. Sockets can be devised to mate with particular plug-ins. Sockets can be specialized so that socket A can only load certain types of plug-ins.

For runtime evaluation, the shared objects 140A through 140Z can guide how data is used in library 110 based on the exchange of parameters between one or more of the plurality of application programs 120A through 120Z and library 110 while employing application procedural interface (API) 125 for two-way communication. More specifically, each of the shared objects 140A through 140Z could include an application personality profile, thereby providing application personalities to guide how data is used and analyzed by the library 10 based on the identity and/or version of the plurality of application programs 120A through 120Z.

The library 110 can also load a model 150 (e.g., a SILICON SMART™ model (SSM)). Model 150 can integrate custom data and algorithmic content into existing industry applications (e.g., PrimeTime, Ambit, DesignCompiler, etc.). The library 110 acts as an interface between OLA applications and SSM(s). Thus, being a translation layer on top of SSM(s), OLA applications including the plurality of application programs 120A through 120Z can readily interact with the SSM(s). The library 110 may be a loader, which can load any SSM to make it OLA-compliant. Such a loader can also load the application personalities via sockets, to guide the process of making the SSM(s) communicate with the OLA applications across API 125.

From the application programs 120A through 120Z perspective, the loader is the library 100 (there is no visibility beyond the OLA-API for the application). Accordingly, the library 110 performs a translation that uses the application personalities to guide the registration and calculation of values within the model 150.

In one embodiment, the model 150 may be OLA-compliant active model for both pre and post-layout flows. Alternatively, the model 150 may not be OLA-compliant. For example, the model 150 can have own set of APIs, which could be different from OLA-API. In particular, the library 110 acting as a loader accepts requests such as OLA requests, and converts them into the model 150 APIs. Thus, it takes the API 125 and converts it—so the model 150 can execute on it.

In operation, the library 110 as a translation layer translates between the OLA calls and SSM(s). Thus, the plurality of application programs 120A through 120Z perceive the library 110 to be OLA-compliant. However, first the SMMs are loaded by the library 110, and then a application personality specific to a particular application comes in and determines how to interface with a particular application and convert those OLA requests in the SSM requests. Accordingly, the loader being the translation layer performs the loading of the application personality, the loading of the SSM(s) and to the particular application it acts as the library 110.

The library 110 can include a model socket 155. The model socket 155 receives a model plug-in for model 150. It is to be understood that the model socket 155 can be readily adapted to receive/support one, or more, such model plug-in(s). The model 150 plug-in is a vehicle to dynamically deliver algorithmic and data content into application flows. The model 150 plug-in can include, but is not limited to, a UNIX shared-object model library (.so) or a WINDOWS dynamic link library (.dll).

Shared model libraries will now be discussed in more detail. Generally, a shared model library can be either a dynamic or a static library. Dynamic libraries are those that contain both algorithms and data whereas static libraries contain data only. While using a static library, each application program is responsible for the interpretation of static data. Since one interpretation of the data in one application program may not be the same as the interpretation in a different application program, inconsistencies can result. As the dynamic libraries contain both data and algorithms, for the same input stimulus, generally all application programs during a design flow that may invoke API 125 with model 150 being an active model could obtain identical results.

The invention includes providing shared objects 140A through 140Z as application personality plug-ins to extend the use of library 110 and/or to optimize the performance of API 125. The application personality plug-ins could provide a mechanism to tune the response of the library 110 for a particular application program. By delivering customer's algorithmic content into the SSM(s) such as the model 150, application personality plug-ins may detect sentinel values and/or resolve protocol conflicts while using the existing OLA API 125. However, it is to be understood, an application personality plug-in can be used for shared libraries (UNIX .so and Windows .dll files) that represent databases or other protocolless systems, not just standard cell libraries, including OLA libraries.

Thus, application personality plug-ins can facilitate relatively faster delay and/or power calculations or modeling for both cells and interconnects. Tuning the response of the model 150 and the library 110 for the plurality of application programs 120A through 120Z enables the library 110 to compute delay and power for any given environment. The application personality plug-ins provide the library 110 with desired intelligence, which is then embedded throughout the design flow. With this methodology, EDA tools can be relied upon for their core competencies (i.e. simulation, synthesis, place and route, path analysis, etc.), while cell, interconnects, and path modeling will be under the control of the library 110.

New applications can be efficiently added to existing design flows through the use of the application personality plug-ins. These application personality plug-ins can be sharedobject libraries which are dynamically loaded into library 110 to provide on-the-fly evaluation of cell and net delays. Persons skilled in the art will appreciate that any appropriate parameter passing mechanism through the optimized use of API 125 enables fast cell and net delay calculations to provide relatively faster timing closure for rapid design convergence. The application personality plug-ins can also be tailored to perform specific operations. For example, an application personality plug-in might be tailored for a particular application program to work with dataset A while another might be specific for dataset B. Yet another might be able to consume both datasets A and B.

In operation, a first plug-in can be dynamically selected and loaded at runtime by the library 110 in response to a dataset identified to be associated with a first application program. The rest of the library 110 can stay the same. If bugs are found within a plug-in algorithm, a new plug-in can be created and distributed without having to redistribute the entire library 110. When a user starts an application program such as a static timing analyzer, the application program loads library 110, and, in turn, library 110 loads one or more active models such as model 150. Selection of the shared objects 140A through 140Z to be loaded as plug-ins can be made by the user via environment variables, configuration file, or extended commands within the application program or model 150.

As a new application program that supports the model 150 and API 125 becomes available, a new application personality plug-in can be uniquely created for that application program. Such a plug-in can include an application personality profile to handle the new application program. Therefore, as new APIs are added to the standard compliant API 125, new plug-ins can be created and distributed to utilize this new functionality without having to build, test, and release new libraries including library 110.

In one exemplary embodiment, library 110 of system 100 can include a cell library. The cell library can be coupled to a cell model compiler. The cell model compiler can include a cell model compiler socket that can couple with a cell model compiler plug-in(s). The cell model compiler may be coupled to a cell database. The cell database could be coupled to the model 150. Furthermore, the system 100 can also include a companion.LIB database that interacts with the model 150 and/or the plurality of application programs 120A through 120Z. Likewise, the system 100 can also include a wireload database to interact with the model 150 and/or the plurality of application programs 120A through 120Z. In addition, a parasitic database can be coupled to an interconnect model compiler. The parasitic database can contain compiled parasitic data, which can be accessed by the model 150 during RCL (resistance-capacitance-inductor) delay calculation.

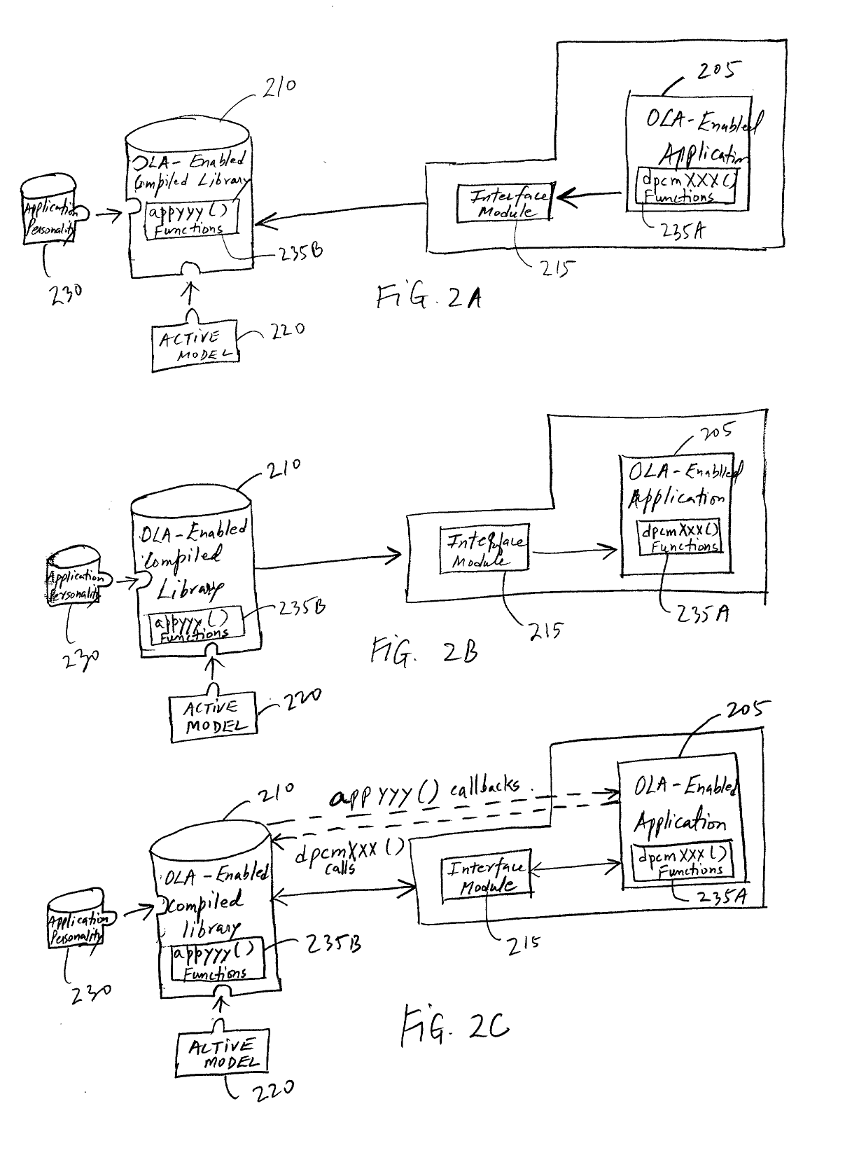

FIGS. 2A, 2B, and 2C illustrate block schematic views with exemplary runtime details consistent with the system 100 depicted in FIG. 1. With reference to FIGS. 2A through 2C, an OLA-enabled application 205 can make a call to an OLA-enabled compiled library 210 through an interface module 215. Persons skilled in the art will appreciate that OLA-enabled compiled library 210 is a shared object. For example, OLA-enabled compiled library 210 being a shared object library with extension “.so” refers to a UNIX based shared library which allows dynamically loadable executable content. However, other forms are possible including a dynamic link library with the extension “.dll” in a WINDOWS environment. The OLA-enabled compiled library 210 can load a SSM active model 220. SSM active model 220 combines data and algorithms to provide dynamic library content and interfaces to OLA-enabled applications including the OLA-enabled application 205 via interface module 215.

The OLA-enabled compiled library 210 may include a first socket 225A for loading in a plug-in for the SSM active model 220. The OLA-enabled compiled library 210 may further include a second socket 225B for loading in an application personality plug-in 230. The application personality plug-in 230, responsive to a dataset identified to be associated with the OLA-enabled application 205, guides how the OLA-enabled compiled library 210 may load in application personality plug-in 230. The dataset may indicate, among other things, the identity and/or version of the OLA-enabled application 205.

The OLA-enabled application 205 communicates with the OLA-enabled compiled library 210 using Open Library API (OLA), where API stands for application procedural interface. The Open Library API includes a set of dpcmYYY( ) functions 235A and a set of appXXX( ) functions 235B. The dpcmYYY( ) 235A and appXXX( ) 235B functions refer to (delay power calculation module) DPCM calls and Application (APP) callbacks, respectively.

The OLA-enabled application 205 employs the set of dpcmYYY( ) functions 235A to make calls to the OLA-enabled compiled library 210. For instance, a dpcmYYY( ) function call might be dpcmGETWireLoadO to get “WireLoad” data/parameters. Likewise, the OLA-enabled compiled library 210 employs the set of appXXX( ) functions 235B to make callbacks to the OLA-enabled application 205. As an example, an appXXX( ) function callback could be appGETParasiticso for requesting “Parasitics” related data/parameters.

In operation, the OLA-enabled application 205 and OLA-enabled compiled library 210 exchange function pointers. Once the function pointers have been exchanged, desired calls and callbacks can be made. More specifically, in an exemplary OLA compilation and runtime process, OLA-enabled application 205 binds to the interface module 215 at compile time. At runtime, the OLA-enabled application 205 employs the interface module 215 to load in OLA-enabled compiled library 210. In particular, OLA-enabled application 205 passes pointers to predetermined or known application functions appXXX ( 235B. The interface module 215 loads OLA-enabled compiled library 210 and passes application function pointers. The OLA-enabled compiled library 210 saves the application function pointers and returns predetermined or known library function pointers to OLA-enabled application 205 through library functions dpcmYYY( ) 235A. The OLA-enabled application 205 stores library function pointers. The OLA-enabled application 205 initiates library actions via dpcmYYY( ) calls 235A. For the delay power calculation, OLA-enabled compiled library 210 through interface module 215 may respond with appXXX( ) callbacks 235B which in turn may cascade to several layers of app/dpcm calls/callbacks. Both the OLA-enabled application 205 and the OLA-enabled compiled library 210 may call common service routines.

For example, a vendor EDA tool such as a timing analyzer, to “model” timing for a test cell at a gate-level, may first request a single shared OLA-enabled compiled library for connectivity and Parasitics information. In response to the request, the single shared OLA-enabled compiled library may return back all the timing paths, and/or any associated constraints available for the cell at a particular point in a design flow. Next, the vendor EDA tool may request the single shared OLA-enabled compiled library to calculate the delay from a first input pin or node to a second output pin or node. Based on such a request, the single shared OLA-enabled compiled library makes a determination that the delay computation is dependent upon the output capacitive load. Therefore, the single shared OLA-enabled compiled library requests the vendor EDA tool to send back appropriate information regarding the output capacitive load. At this point in the design flow, the vendor EDA tool may only know about the connectivity, but there is no information available for input pin capacitance of the three gates that are being driven by the second output pin of the test cell. However, from the prior request of connectivity information, the vendor EDA tool knows that an OR gate is being driven by the second output pin of the test cell.

Accordingly, another request is sent to the single shared OLA-enabled compiled library asking for appropriate information to be sent back regarding pin capacitance of the particular identified pin of the OR gate. The single shared OLA-enabled compiled library responds with the pin capacitance value for the particular identified pin of the OR gate. Next, the vendor EDA tool forwards this pin capacitance value as the output capacitive load on the second output pin of the test cell. Finally, the single shared OLA-enabled compiled library can calculate the delay for the test cell as now the load is known to it.

In this example, the OLA-enabled application 205 includes a static timing analyzer that is coupled to the OLA-enabled compiled library 210 being a delay power calculation module loader, and in-turn to the SSM active model 220. A wire load model (.so) may be loaded from a cell database by DPCM SSM Loader (.so). Parasitic data can be loaded from a parasitic database to model plug-ins such as the net delay calculator Plug-in (.so). DPCM SSM Loader dynamically loads SSM model 220, a wire load model, and an application personality plug-in. DPCM SSM Loader also provides an abstraction layer that makes SSMs substantially portable across applications. OLA-enabled application 205 communicates via an OLA API link with the DPCM SSM Loader (.so).

If an OLA application can choose which APIs it supports, an application personality plug-in can be tailored to the specific application and application version to boost performance. If an OLA application is not strictly compliant to the API data structures, it may use special sentinel values in place of legitimate data values. A plug-in tailored for that application could detect such sentinel values and take the appropriate action. Sentinel values can change from version to version and application to application. If an OLA application is not strictly compliant to the API data structures, operations on certain data items, or callbacks based on those data value, may generate inaccurate responses or even cause the program to terminate unexpectedly. However, an application personality plug-in can be tailored to avoid those problems. In addition, an OLA application may provide services that allow the plug-in to extend the functionality of the application.

In one embodiment, a C++ class-based API is generally provided for speed and extensibility. Moreover, all library functions are coded in C++ as well. Plug-ins to the OLA-enabled compiled library 210 provides dynamic adaptation of algorithmic content and preferably SSM model 220 can handle both cell and net (stage delay). Both pre-and post-layout models are supported. The pre-layout models use wireload information and the post-layout models use extracted network interconnect, instance specific data. Plug-ins to OLA-enabled compiled library 210 can embed vendor's data and algorithms. Data can be in any form as long as the algorithm can consume it. For plug-ins, C++ inheritance from a known object oriented class base is used to simplify development and runtime use. For signature verification, either plug-ins create content and associate a signature with that content or plugins consume content with known signatures. OLA-enabled compiled library 210 is a shared library and comprises library content as a C++ based executable module which is portable to any OLA-enable application including OLA-enabled application 205. The wire load model is also a shared object library representing the wire load models. The companion LIB provides pin attributes and functions.

Additionally, a set of SSM managers including a backplane, instance manager, stage delay manager, and cell/net delay managers may be employed to interface and coordinate various functions. For example, the backplane may enable loading of various types of plugins and coordinate with instance manager to obtain and report instance specific cell and net delay to the application. The instance manager may interface with external applications via direct interface (UNIX TCP/IP) socket to obtain instance specific cell and net delay information. The stage delay manager may coordinate requests for cell and net delay as cell delays and slews generally need net characteristics, and vice versa. The cell/net delay managers may coordinate selection of instance specific data or algorithmic data. Moreover, the cell/net delay managers could be responsible for loading algorithmic content plug-ins for dynamic evaluation.

In one embodiment a method is provided for using a set of first programs with a second program. The method generally comprises providing an application procedural interface for communication between the set of first programs and the second program. In turn, providing, through the use of the application procedural interface, to the second program at least one of a set of plug-ins from a database responsive to a dataset identified to be associated with the at least one of the set of first programs. The at least one of the set of first programs may be identified for the second program by analyzing the dataset with the second program.

Before providing the application procedural interface, at least one of a set of the plug-ins may be created for supporting operation of the second program with the at least one of the set of first programs. The second program may include an active dynamic library including one or more active models, each of the one or more active models having an associated data and algorithmic content. The set of first programs may include a plurality of application programs deployed in a design flow of an integrated circuit. The application procedural interface may include a first set of functions having a first number of fields to pass a first set of one or more parameters for the set of first programs, and a second set of functions having a second set of fields to pass a second set of one or more parameters for the second program. The first set of functions may be calls and second set of functions may be callbacks.

In one embodiment a system generally comprises an interface to communicate between a set of first programs and a second program, and a set of third programs. The one of the set of first programs loads in the second program and the second program, responsive to a dataset from one of the set of first programs, loads in at least one of the set of third programs. The dataset is identified to be associated with the at least one of the set of first programs. The at least one of the set of third programs is a plug-in to the second program.

In another embodiment, a system is provided for using a set of first programs with a second program. The system generally comprises an application procedural interface for communication between the set of first programs and the second program, and a database including a set of plug-ins. The one of the set of first programs loads in the second program and the second program is responsive to a dataset from one of the set of first programs to load in at least one of the set of plug-ins. The database may include a directory having the set of plug-ins organized in a file system. Each of the set of plug-ins includes an application personality profile for an associated one of the set of first programs. The application personality profile determines an optimized sequence of function calls between the associated one of the set of first programs and the second program. The optimized sequence is derived responsive to the dataset.

In yet another embodiment, a system generally comprises an application procedural interface for extending a dynamic library for use with a first application program and a second application program. First and second plug-ins are provided for the first and second application programs, respectively. In operation, the dynamic library loads the first plug-in responsive to the first application program, and, in turn, the dynamic library loads the second plug-in responsive to the second application program. The first and second plug-ins may be stored in a library/location or in different libraries/locations.

Each of the first and second plug-ins could include a first set of one or more parameters to be monitored, a first rule for at least one of the first set of one or more parameters, a second set of one or more parameters to be processed, and a second rule for at least one of the second set of one or more parameters. Further, a first routine responsive to a set of transactions through the application procedural interface may store appropriate information on transactions affecting one or more of the first set of one or more parameters and one or more of the second set of one or more parameters. Likewise, a second routine responsive to the first routine may invoke one of a first set of actions in response to the at least one of the first set of one or more parameters failing to comply with the first rule. And may invoke one of a second set of actions in response to the at least one of the second set of one or more parameters being generated according to the second rule.

The term coupled, as used herein, is defined as connected, although not necessarily directly, and not necessarily mechanically. The term program or phrase computer program, as used herein, is defined as a sequence of instructions designed for execution on a computer system. A program may include a subroutine, a function, a procedure, an object method, an object implementation, an executable application, an applet, a servlet, a source code, an object code, and/or other sequence of instructions designed for execution on a computer system.

While not being limited to any particular performance indicator or diagnostic identifier, preferred embodiments of the invention can be identified one at a time by testing for the presence of rapid convergence. The test for the presence of rapid convergence can be carried out without undue experimentation by the use of a simple and conventional time measurement experiment.

### EXAMPLES

Specific embodiments of the invention will now be further described by the following, nonlimiting examples which will serve to illustrate in some detail various features of significance. The examples are intended merely to facilitate an understanding of ways in which the invention may be practiced and to further enable those of skill in the art to practice the invention. Accordingly, the examples should not be construed as limiting the scope of the invention.

### Example 1

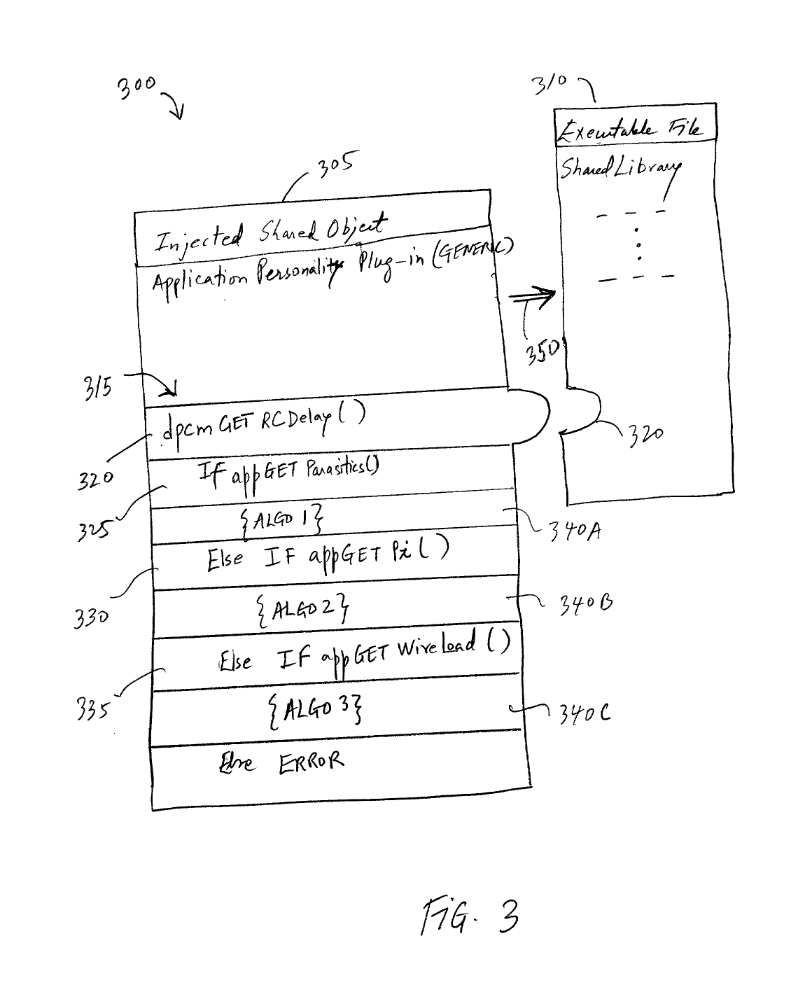

FIG. 3 illustrates an exemplary plug-in architecture 300 consistent with the present invention. The exemplary plug-in architecture 300 comprises a generic application personality plug-in 305 for a set of already profiled vendor EDA tools (not shown) and an executable file 310 for a single shared library. The generic application personality plug-in 305 includes a generic decision tree 315, which may be interjected as a shared object in the executable file 310. The generic application personality plug-in 305 is advantageously devised to service all the set of already profiled vendor EDA tools.

The executable file 310 comprises accurate timing and power modeling information. Of course, persons skilled in the art will recognize a variety of plug-in architectures may be readily devised for a desired application program, library, and/or platform selected for implementing the exemplary plug-in architecture illustrated in FIG. 3. For loading in the generic application personality plug-in 305, the executable file 310 includes a socket 320. The generic application personality plug-in 305 could be stored in a database.

Referring to FIG. 3, the generic decision tree 315 includes a dpcmGETRCDelay ( ) call 320 and a set of appXXX( ) callbacks. Specifically, the set of appXXX( ) callbacks includes a appGETParasitics( ) callback 325, appGETPi( ) callback 330, and appGETWireLoad( ) callback 335. Further algorithms 340A through 340C may be interjected in the generic decision tree 315. For example, Application Specific Integrated Circuit (ASIC) vendors such as Texas Instruments Corporation of Dallas, Tex. could provide algorithms 340A through 340C.

The generic decision tree 315 is advantageously devised to service a particular application program. In response to a dataset identified to be associated with the particular application program, the generic application personality plug-in 305 may be loaded in and interjected as a shared object within the executable file 310. The data set may include monitored and processed parameters indicative of type and/or version of the particular application program. It is to be understood that some application programs may be non-OLAcompliant as they could employ proprietary parameters. For example, monitored parameters could be sentinel values to indicate non-compliant nature of the application programs. Accordingly, a variety of sentinel values may be monitored. Likewise, to perform desired calculations, a variety of processed parameters may be exchanged.

Using an OLA-compliant API 350, appropriate monitored and/or processed parameters may be exchanged between generic application personality plug-in 305 and the executable file 310. With the OLA-compliant API 350, the set of already profiled vendor EDA tools may provide the executable file 310 appropriate information by traversing through the generic decision tree 315. The set of already profiled vendor EDA tools may include environment variables. For example, a vendor EDA tool may be profiled by keying off a directory path parameter generally present within an initialization file (*.ini) associated with the vendor EDA tool. While the delay and/or power computation is done entirely by the executable file 310, the set of vendor EDA tools may perform their own function such as simulation, synthesis, or floor planning. Thus, a desired computation may be provided through a sequence of calls and callbacks between the single shared OLA-enabled compiled library and the set of vendor EDA tools.

However, not every appXXX( ) callback may be desired to be supported by every application program from the set of vendor EDA tools. Likewise, not every dpcmYYY( ) calls may be desired to be supported by the single shared OLA-enabled compiled library. Although the single shared OLA-enabled compiled library is being used across multiple application programs, it is desired that the single shared OLA-enabled compiled library supports all the dpcmYYY( ) calls which may be substantially more that the total number of appXXX( ) callbacks. Accordingly, application program specific plug-ins may be devised to include one or more selected application personality profiles, thereby providing significantly improved design convergence.

Therefore, if the single shared OLA-enabled compiled library knows that a particular application program only supports “WireLoad” data, traversing through the whole generic decision tree 315 could be avoided whenever only the “WireLoad” data is needed. As there could be substantial penalty in terms of time that is wasted while going through appGETParasitics( ) callback 325 and appGETPi( ) callback 330 to reach appGETWireLoad( ) callback 335.

### Example 2

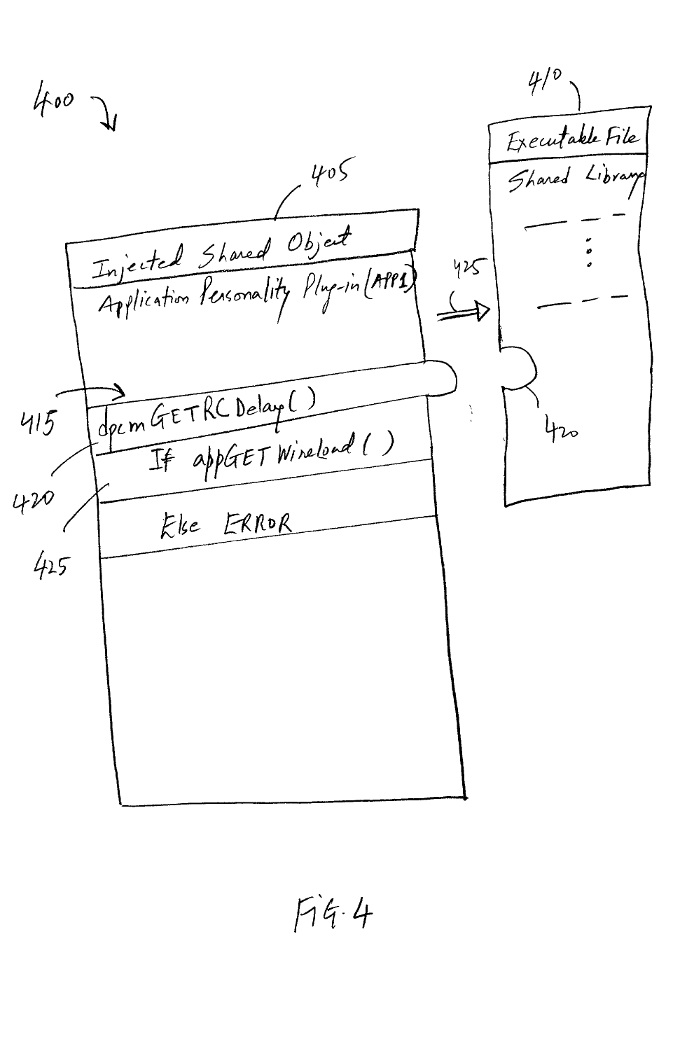

FIG. 4 illustrates another exemplary plug-in architecture 400 consistent with the present invention. The exemplary plug-in architecture 400 comprises a custom application personality plug-in 405 for a vendor EDA tool (not shown) and an executable file 410 for a single shared library. The customized application personality plug-in 405 includes a truncated decision tree 415, which may be interjected as a shared object in the executable file 410. For loading in the customized application personality plug-in 405, the executable file 410 includes a socket 420.

The truncated decision tree 415 includes a dpcmGETRCDelay( ) call 420 and a appGETWireLoado callback 425. The truncated decision tree 415 is advantageously devised to service a particular application program. In response to a dataset identified to be associated with the particular application program, the customized application personality plug-in 405 may be loaded in and interjected as a shared object within the executable file 410. The dataset may include monitored and processed parameters indicative of type and/or version of the particular application program. For example, monitored parameters could be sentinel values. The customized application personality plug-in 405 could be stored in a database such as within a directory where one or more such plug-ins may be readily organized within a file system.

As shown in FIG. 4, using an OLA-compliant API 435, appropriate parameters may be passed back and forth between generic application personality plug-in 405 and the executable file 410 for a single shared library. With the OLA-compliant API 435, the vendor EDA tool may provide the executable file 410 appropriate information by traversing through the truncated decision tree 415. While the delay and/or power computation is done entirely by the executable file 410, the vendor EDA tool performs its own function such as simulation, synthesis, or floor planning. Thus, a desired computation may be provided through an optimized sequence of calls and callbacks between the single shared OLA-enabled compiled library and the vendor EDA tool.

Accordingly, the overall goal of rapid convergence may be accomplished efficiently with the use of a single shared library that can be used by multi-vendor EDA tools. Each vendor EDA tool may be presented with the same data and algorithms that will allow for rapid convergence. A customer can create a single shared OLA-enabled compiled library. The single shared OLA-enabled compiled library is a binary executable file that contains function, properties, and the alike for providing a capability to compute delay and power. The single shared OLA-enabled compiled library being in executable form can be dynamically loaded in to a vendor EDA tool at runtime. Any desired information regarding timing and power may be extracted from the single shared OLA-enabled compiled library by the vendor EDA tool via the OLA-compliant APIs. The single shared OLA-enabled compiled library includes all timing and power information including detailed interconnect delay calculation. As a result, the system 100 can compute consistent timing and power across any deployed vendor EDA tools.

Clearly, static libraries and wireloads worked in previous generations of ICs. However, VDSM effects present a new challenge that requires active models. IEEE standard 1481 (OLA) provides a consistent API framework for applications and libraries. A plug-in based design methodology for VDSM technologies can include a host of previously ignored or approximated electrical and physical artifacts of cell models into mainstream design/application flows. Such design methodology can self-compute for a given environmental condition (i.e. voltage, temperature, process, and RLC load). Binding algorithms with the data permits this sort of self-evaluation for the API based executable cell models. Programmable API-based models can evaluate delay values for any given unique environment. This provides accurate representation of whole path delays, so the use of advanced process technologies can be maximized in the most efficient and productive way.

### Example 3

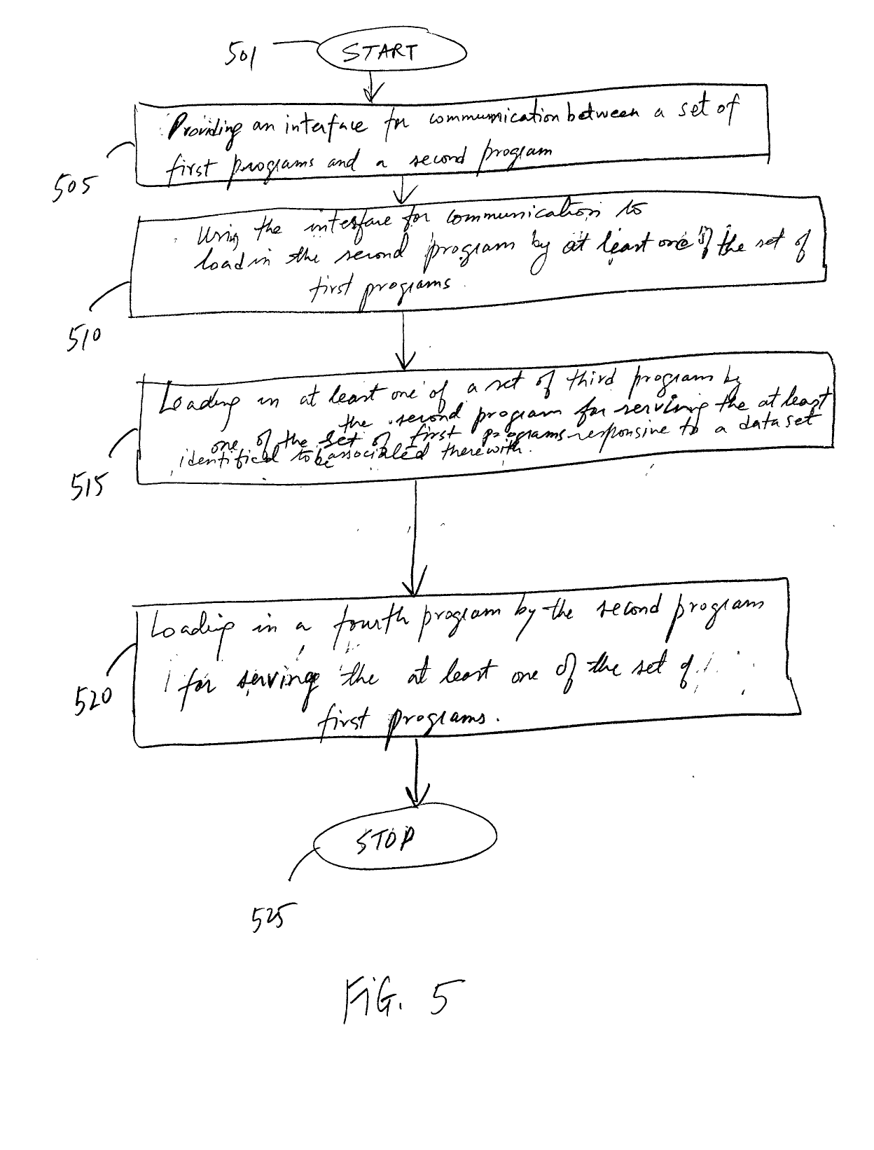

FIG. 5 illustrates a flow diagram of a process that can be implemented by a computer program, representing an embodiment of the invention. Referring to FIG. 5, a sequence of method steps will be described in the form of a flow chart. The sequence of method steps is merely an example of a way in which the invention could be embodied. After a start 501, an interface for communication between a set of first programs and a second program is provided at 505. The set of first programs includes a set of application programs for electronic design automation. The second program includes a shared object having a generic code for use with the set of first programs. For example, the second program may include a dynamic link library having a plurality of generic macros for use with the set of first programs.

Using the interface for communication, one of the set of first programs loads in the second program at 510. At 515, responsive to a dataset identified to be associated with at least one of the set of first programs at least one of a set of third programs associated with at least one of the set of first programs is provided to the second program. Specifically, the second program loads in at least one of the set of third programs for serving at least one of the set of first programs. The set of third programs includes a plurality of application specific shared objects, each application specific shared object having one or more application specific macros associated with at least one of set of first programs. For example, the set of third programs may include a plurality of application specific dynamic link libraries, each application specific dynamic link library having one or more application specific macros associated with one or more of set of first programs.

At 520, the second program loads in a fourth program for serving at least one of the set of first programs before reaching stop 525. The fourth program includes one or more active models. Each active model may include a dataset and an algorithmic content. The forth program is being shared generally by the set of first programs. Accordingly, at least one of the set of first programs may communicate with the fourth program through the second program while utilizing at least one of the set of third programs. Alternatively, at least one of the set of first programs could communicate directly with the fourth program while utilizing at least one of the set of third programs.

A communication from at least one of the set of first programs to the second program may include making a call having the dataset, and directing the call to a selected one of the set of third programs responsive to a first determination from the dataset. Alternatively, a communication from at least one of the set of first programs to the second program may include making a call having the dataset, and responding to at least one of the set of first programs responsive to a second determination from the dataset. In either case, however, a callback may be executed from at least one of the set of third programs to at least one of the set of first programs for determining a response to the call.

The dataset may include a first set of one or more monitored parameters and a second set of one or more operational parameters. The first determination may include checking the dataset for at least one monitored parameter from the first set of one or more monitored parameters. Checking of the dataset may be performed using a first set of actions responsive to presence of at least one monitored parameter, and performing a second set of actions responsive to absence of at least one monitored parameter. The first set of actions may include responding to at least one of the first set of first programs with a query for determining a next action. The second set of actions may include optimizing a sequence of calls/callbacks as a function of the dataset associated with at least one of the first set of first programs.

An integrated circuit may be designed and/or verified in accordance with the method steps of FIG. 5. The set of third programs includes application personality plug-ins. Each application personality is preferably a computer program comprising a set of instructions (program code) encoded on computer-readable medium.

### Practical Applications of the Invention

A practical application of the invention that has value within the technological arts is creating and verifying the design of an integrated circuit. Further, the invention is useful in conjunction with integrated circuit design optimization. For example, the invention enables an efficient interaction between a design library and one or more design tools. In particular, the invention can obviate problems occurring related with non-compliant design tools having propriety parameters exchanged. For example, a design library may be enabled to communicate specific analytical questions and examine the responses by a new and/or updated design tool. Conversely, the new and/or updated design tool may be enabled to communicate particular analytical questions and examine the responses by the design library. Such two-way communication may satisfy the above-discussed requirement of increased performance and consistency. Thus, a design library could be readily utilized with a new software product or a newer version of an already installed software product. There are virtually innumerable uses for the invention, all of which need not be detailed here.

### Advantages of the Invention

A computer program, representing an embodiment of the invention, can be cost effective and advantageous for at least the following reasons. In a design flow, supporting and use of a single shared library across multiple applications and vendors can be a daunting task. For example, efficient distribution data and algorithmic content to an OLA-enabled compiled library such as a Delay (Power) Calculation Module (DPCM) can be problematic in the event of integration of new application programs or vendor design tools in the design flow. Accordingly, the invention reduces the complexity of dynamically delivering data and algorithmic content. The invention simplifies development, distribution, and licensing of the data and algorithmic content. Therefore, rapid design convergence may be achieved while using disparate vendor and in-house design tools with a substantially portable library.

All the disclosed embodiments of the invention described herein can be realized and practiced without undue experimentation. Although the best mode of carrying out the invention contemplated by the inventors is disclosed above, practice of the invention is not limited thereto. Accordingly, it will be appreciated by those skilled in the art that the invention may be practiced otherwise than as specifically described herein.

For example, the individual components need not be combined in the disclosed configuration, but could be combined in virtually any configuration. Further, although the plug-ins described herein can be separate modules, it will be manifest that the plug-ins may be integrated into the system with which it is associated. Furthermore, all the disclosed elements and features of each disclosed embodiment can be combined with, or substituted for, the disclosed elements and features of every other disclosed embodiment except where such elements or features are mutually exclusive.

It will be manifest that various additions, modifications and rearrangements of the features of the invention may be made without deviating from the spirit and scope of the underlying inventive concept. It is intended that the scope of the invention as defined by the appended claims and their equivalents cover all such additions, modifications, and rearrangements.

The appended claims are not to be interpreted as including means-plus-function limitations, unless such a limitation is explicitly recited in a given claim using the phrase “means for.” Expedient embodiments of the invention are differentiated by the appended subclaims.

What is claimed is:

1. A method, comprising:
providing an interface for communication between a set of first programs and a second program; and
providing to the second program at least one of a set of third programs associated with at least one of the set of first programs, in response to a dataset associated with said at least one of the set of first programs, wherein the at least one of the set of third programs selectively modifies the interface for communication between the second program and said at least one of the set of first programs.

2. The method of claim 1, wherein providing to the second program includes:
loading in the second program by one of the set of first programs; and
loading in at least one of the set of third programs by the second program for tuning the response of said second program to the at least one of the set of first programs.

3. The method of claim 1, wherein providing to the second program includes loading in a fourth program by the second program for serving the at least one of the set of first programs.

4. The method of claim 1, wherein the set of first programs includes a set of application programs for electronic design automation.

5. The method of claim 1, wherein the second program includes a shared object having a generic code for use with the set of first programs.

6. The method of claim 1, wherein the second program includes a dynamic link library having a plurality of generic macros for use with the set of first programs.

7. The method of claim 1, wherein the set of third programs includes a plurality of application specific shared objects, each application specific shared object having one or more application specific macros associated with the at least one of set of first programs.

8. The method of claim 1, wherein the set of third programs includes a plurality of application specific dynamic link libraries, each application specific dynamic link library having one or more application specific macros associated with one or more of set of first programs.

9. The method of claim 3, wherein the fourth program includes one or more active models, each active model having a dataset and an algorithmic content, the forth program being shared by the set of first programs.

10. The method of claim 9, wherein the at least one of the set of first programs communicates with the fourth program through the second program while utilizing the at least one of the set of third programs.

11. The method of claim 9, wherein the at least one of the set of first programs communicates directly with the fourth program while utilizing the at least one of the set of third programs.

12. The method of claim 1, wherein providing includes:
making a call having the dataset from the at least one of the set of first programs to the second program; and
directing the call to a selected one of the set of third programs responsive to a first determination from the dataset.

13. The method of claim 12, wherein the dataset includes a first set of one or more monitored parameters and a second set of one or more operational parameters.

14. The method of claim 13, wherein the first determination includes checking the dataset for at least one monitored parameter from the first set of one or more monitored parameters.

15. The method of claim 14, wherein checking includes:
performing a first set of actions responsive to presence of the at least one monitored parameter; and
performing a second set of actions responsive to absence of the at least one monitored parameter.

16. The method of claim 15, wherein performing the first set of actions includes responding to the at least one of the first set of first programs with a query for determining a next action.

17. The method of claim 15, wherein performing the second set of actions includes optimizing a sequence of calls as a function of the dataset associated with the at least one of the first set of first programs.

18. The method of claim 12, wherein providing includes making a callback from the at least one of the set of third programs to the at least one of the set of first programs for determining a response to the call.

19. The method of claim 1, wherein providing includes:
making a call having the dataset from the at least one of the set of first programs to the second program; and
responding to the at least one of the set of first programs responsive to a second determination from the dataset.

20. A method for using a set of first programs with a second program, comprising:
providing an application procedural interface for communication between the set of first programs and the second program; and
providing, through the use of the application procedural interface, to the second program at least one of a set of plug-ins from a database responsive to a dataset identified to be associated with said at least one of the set of first programs.

21. The method of claim 20, wherein providing includes identifying said at least one of the set of first programs to the second program by analyzing the dataset with the second program.

22. The method of claim 20, further comprising, before providing said application procedural interface, creating said at least one of a set of the plug-ins for supporting operation of the second program with said at least one of the set of first programs.

23. The method of claim 20, wherein the second program includes an active dynamic library including one or more active models, each of said one or more active models having an associated data and algorithmic content.

24. The method of claim 20, wherein the set of first programs includes a plurality of application programs deployed in a design flow of an integrated circuit.

25. The method of claim 20, wherein the application procedural interface includes:
a first set of functions having a first number of fields to pass a first set of one or more parameters for the set of first programs; and
a second set of functions having a second set of fields to pass a second set of one or more parameters for the second program.

26. The method of claim 25, wherein each of said first set of functions includes a call.

27. The method of claim 25, wherein each of said second set of functions includes a callback.

28. A system, comprising:
an interface to communicate between a set of first programs and a second program; and
a set of third programs, wherein one of the set of first programs loads in the second program and the second program, responsive to a dataset from one of the set of first programs, loads in at least one of the set of third programs.

29. The system of claim 28, wherein said dataset is identified to be associated with said at least one of the set of first programs.

30. The system of claim 28, wherein said at least one of the set of third programs is a plug-in to said second program.

31. A system for using a set of first programs with a second program, comprising:
an application procedural interface for communication between the set of first programs and the second program; and
a database including a set of plug-ins, wherein one of the set of first programs loads in the second program and the second program is responsive to a dataset from one of the set of first programs to load in at least one of the set of plug-ins.

32. The system of claim 31, wherein said database includes a directory having the set of plug-ins organized in a file system.

33. The system of claim 31, wherein each of said set of plug-ins includes an application personality profile for an associated one of the set of first programs, the application personality profile determines an optimized sequence of function calls between the associated one of the set of first programs and the second program, said optimized sequence responsive to the dataset.

34. A system, comprising:
an application procedural interface for extending a dynamic library for use with a first application program and a second application program;
a first plug-in, wherein the dynamic library loads the first plug-in responsive to the first application program; and
a second plug-in, wherein the dynamic library loads the second plug-in responsive to the second application program.

35. The system of claim 34, wherein said first plug-in is stored in a library.

36. The system of claim 35, wherein said first and second plug-ins are stored in said library.

37. The system of claim 34, wherein said each plug-in includes:
a first set of one or more parameters to be monitored;
a first rule for at least one of the first set of one or more parameters;
a second set of one or more parameters to be processed;
a second rule for at least one of the second set of one or more parameters;
a first routine responsive to a set of transactions through the application procedural interface, the first routine stores information on transactions affecting one or more of the first set of one or more parameters and one or more of the second set of one or more parameters; and
a second routine responsive to the first routine, the second routine invokes one of a first set of actions in response to said at least one of the first set of one or more parameters failing to comply with the first rule, and invokes one of a second set of actions in response to said at least one of the second set of one or more parameters being generated according to the second rule.

38. An electronic media, comprising a program for performing the method of claim 1.

39. A computer program, comprising computer or machine-readable program elements translatable for implementing the method of claim 1.

40. The method of claim 1, further comprising verifying a design of an integrated circuit.

41. An integrated circuit designed in accordance with the method of claim 1.

42. A computer program comprising computer program means adapted to perform the steps of providing an interface for communication between a set of first programs and a second program; and providing to the second program at least one of a set of third programs associated with at least one of the set of first programs responsive to a dataset identified to be associated with said at least one of the set of first programs when said at least one of the set of first programs is run on a computer.

43. A computer program as claimed in claim 42, embodied on a computer-readable medium.

44. An electronic media, comprising a program for performing the method of claim 20.

45. A computer program, comprising computer or machine-readable program elements translatable for implementing the method of claim 20.

46. The method of claim 20, further comprising verifying a design of an integrated circuit.

47. An integrated circuit designed in accordance with the method of claim 20.

48. A computer program comprising computer program means adapted to perform the steps of providing an application procedural interface for communication between a set of first programs and a second program; and providing, through the use of the application procedural interface, to the second program at least one of a set of plug-ins from a database responsive to a dataset identified to be associated with said at least one of the set of first programs when said at least one of the set of first programs is run on a computer.

49. A computer program as claimed in claim 48, embodied on a computer-readable medium.

50. A method for using a first program with a second program, comprising:
communicating an indication from the first program to the second program;
analyzing the indication to determine an interaction between the first and second program; and
utilizing a third program to tune the interaction between the first program and the second program.
